(19) United States
(12) Patent Application Publication
(10) Pub. No.: US 2013/0025179 A1
(43) Pub. Date: Jan. 31, 2013

(54) FISHING HOOK

(71) Applicant: Teruhiro Tsutsumi, Hamamatsu-shi (JP)

(72) Inventor: Teruhiro Tsutsumi, Hamamatsu-shi (JP)

(73) Assignee: SHINTOWA CO., LTD., Hamamatsu-shi (JP)

(21) Appl. No.: 13/571,246

(22) Filed: Aug. 9, 2012

Related U.S. Application Data
(63) Continuation of application No. PCT/JP2011/052416, filed on Feb. 4, 2011.

(30) Foreign Application Priority Data
Feb. 9, 2010 (JP) 2010-026106

(51) Int. Cl. A01K 83/00; A01K 97/12

(52) U.S. Cl. 43/17.5; 43/43.16

(57) ABSTRACT

A fishing hook can include a light-emitting element provided on a base end side of a hook body. Various types of natural and/or artificial bait can be used with the fishing hook. A fish-attracting effect can be imparted to the fishing hook itself, and the light-emitting element can suppress separation of the bait. A light-emitting element, in which a light-emitting sheet capable of emitting light from a phosphorescent material and/or luminescent material and a multilayer polymer film having a light-interfering phenomenon are laminated, is attached to the base end side of the hook body. The light-emitting sheet and the multilayer polymer film in the light-emitting element can be wound upon the base end side of the hook body in a laminated state, and a fishing line or affixing line can be wound and affixed upon the front surface side of the light-emitting element to form an uneven surface.

### CROSS-REFERENCE TO RELATED APPLICATIONS

This is a continuation of PCT Application No. PCT/JP2011/052416, filed on Feb. 4, 2011, which claims priority to Japanese Patent Application No. 2010-026106, filed on Feb. 9, 2010. The foregoing applications are hereby incorporated by reference herein in their entirety.

### BACKGROUND

1. Field

The present invention relates to fishing hooks to be used for fishing in a river and/or fishing in the sea and particularly to a fishing hook having a light-emitting element on the base end side of a hook body and capable of increasing a fish-attracting effect.

2. Description of the Related Art

A fishing hook designed for natural bait is disclosed in Japanese Unexamined Patent Application Publication No. 2007-53997. This fishing hook includes a hook portion having a point at the tip end and a hook body extending from the hook portion, the hook body having a line attachment portion on the base end side, and a large number of holes formed in the side face of the hook body.

A fishing hook designed for use with artificial bait as a lure is disclosed in Japanese Unexamined Patent Application Publication No. 2005-278583. This fishing hook, having a hook portion and a hook body, includes a ring-shaped attachment portion coupled to an eye of the lure body to which a light-emitting element is detachably attached in a hollow portion inside.

### SUMMARY OF THE INVENTIONS

In the fishing hook described in Japanese Unexamined Patent Application Publication No. 2007-53997, the large number of holes provided in the hook body makes it difficult for natural bait such as angleworms, lugworms and the like to separate from the fishing hook. However, the holes need to be made in the hook body, and making such holes is extremely cumbersome, particularly when the fishing hook is small. Further, the fishing hook is formed merely by bending a high-carbon steel wire or high-carbon stainless steel wire, and a fish-attracting effect cannot be imparted to the fishing hook itself. Moreover, in the fishing hook described in Japanese Unexamined Patent Application Publication No. 2005-278583, the fish-attracting effect can be imparted to some degree to the light-emitting element of the lure body, but since the fishing hook is formed only by bending a wire similarly to the fishing hook in Japanese Unexamined Patent Application Publication No. 2007-53997, it is difficult to impart the fish-attracting effect to the fishing hook itself

The present disclosure was made in view of the above-described circumstances and an object thereof is to provide a fishing hook that can be used both for natural bait and various types of artificial bait and can impart a fish-attracting effect to the fishing hook itself by providing a light-emitting element on the base end side of the hook body, the hook body formed by bending a wire. Another object of the present invention is to provide a fishing hook in which the light-emitting element can have a function of suppressing separation of bait.

Thus, in accordance with an embodiment, a fishing hook can include a hook portion having a sharp point at the tip end and a substantially C-shaped bent portion, and a hook body provided continuously to the hook portion and having an attachment portion to which a fishing line or artificial bait can be attached on the base end side. In some such embodiments, a light-emitting element comprising a light-emitting sheet configured to emit light from a phosphorescent material and/or luminescent material and a multilayer polymer film having an interference phenomenon of light is attached to the base end side of the hook body.

In such embodiments, which include the light-emitting sheet that is capable of emitting light from a phosphorescent material or luminescent material and the multilayer polymer film having an interference phenomenon of light are laminated is attached on the base end side of the hook body formed by bending a wire, the light-emitting element can brilliantly flash during the daytime while it emits light and shines at night. Such embodiments can be used with natural bait, artificial bait imitating natural bait, or artificial bait such as a lure, and a sufficient fish-attracting effect can be imparted to the fishing hook itself.

Additional benefits can be achieved by embodiments in which the light-emitting sheet and the multilayer polymer film are wound upon the base end side of the hook body in a laminated state, and the fishing line (leader) or affixing line such as an affixing gut is wound and affixed upon the front surface side thereof. In such embodiments, separation of the bait such as natural bait or artificial bait imitating the natural bait from the hook body can be suppressed on the uneven surface caused by the fishing line or affixing line wound and affixed upon the front surface side of the light-emitting element.

Further benefits can be achieved by embodiments in which a connecting line capable of being connected to an eye of the artificial bait is attached to the attachment portion formed to have a ring shape on the hook body. In some such embodiments, the fishing hook can be used as a fishing hook for artificial bait such as a lure, and by setting the length of the connecting line to a desirable length, a range of applications of the lure can be expanded. For example, the fish-attracting effect can be increased by the light-emitting element of the fishing hook while the artificial bait is used as a weight.

Furthermore, since the light-emitting sheet is formed of a sheet having high visibility from one face side and excellent transparency from the other face side, the light-emitting sheet can store sufficient light and emit light reliably to the multilayer polymer film, and the fish-attracting effect can be further increased by the light-interfering phenomenon of the polymer film.

Additional benefits can be achieved by embodiments in which a filamentous body made of a plurality of threads is attached to the outside of the light-emitting element. In such embodiments, the fish-attracting effect obtained by the light-emitting element can be further increased by forming the filamentous body with a luminescent material, and by forming the filamentous body with feather, versatility of the fishing hook can be increased. For example, the fishing hook can be used as an artificial fly.

Further benefits can be achieved by embodiments in which the light-emitting sheet comprises a sheet having a first surface and a second surface, the first surface facing away from the fishing hook and the second surface facing toward the fishing hook. In such embodiments, the first surface of the sheet can include one or more colors and can be configured to increase the visibility of the sheet. The second surface can be transparent, substantially transparent, opaque, substantially opaque, or translucent. In some embodiments, the first surface comprises one or more colors and/or patterns.

In accordance with an embodiment, a fishing hook can include a hook portion having a sharp point at the tip end and a substantially C-shaped bent portion, and a hook body provided continuously to the hook portion and having an attachment portion to which a fishing line or artificial bait can be attached on the base end side. In some such embodiments, a light-emitting means is attached to the base end side of the hook body. In such embodiments, the light-emitting means can brilliantly flash during the daytime while it emits light and shines at night. Such embodiments can be used with natural bait, artificial bait imitating natural bait, or artificial bait such as a lure, and a sufficient fish-attracting effect can be imparted to the fishing hook itself.

Additional benefits can be achieved by embodiments in the fishing line (leader) or affixing line such as an affixing gut is wound and affixed upon the light-emitting means. In such embodiments, separation of the bait such as natural bait or artificial bait imitating the natural bait from the hook body can be suppressed on the uneven surface caused by the fishing line or affixing line wound and affixed upon the light-emitting means.

Further benefits can be achieved by embodiments in which a connecting line capable of being connected to an eye of the artificial bait is attached to the attachment portion formed to have a ring shape on the hook body. In some such embodiments, the fishing hook can be used as a fishing hook for artificial bait such as a lure, and by setting the length of the connecting line to a desirable length, a range of applications of the lure can be expanded. For example, the fish-attracting effect can be increased by the light-emitting means of the fishing hook while the artificial bait is used as a weight.

### BRIEF DESCRIPTION OF THE DRAWINGS

These and other features, aspects, and advantages are described below with reference to the drawings, which are intended to illustrate but not to limit the disclosure.

FIG. 1 is a front view illustrating an embodiment of a fishing hook.

FIG. 2 is a side view of a line attachment portion of a hook body of the fishing hook of FIG. 1.

FIG. 3 is a sectional view of the fishing hook of FIG. 1 along the plane A-A.

FIG. 4 is a longitudinal sectional view of a light-emitting element of the fishing hook of FIG. 1.

FIG. 5 is a process chart illustrating a method of manufacturing the fishing hook of FIG. 1.

FIG. 6 is an explanatory diagram of a use state of the fishing hook of FIG. 1.

FIG. 7 includes a side view (FIG. 7(a)) and a front view (FIG. 7(b)) illustrating a variation of the line attachment portion of the fishing hook of FIG. 1.

FIG. 8 is a partial-sectional view of a main part illustrating a variation of the hook body of the fishing hook of FIG. 1.

FIG. 9 is a front view illustrating a variation of a light-emitting element of a fishing hook.

FIG. 10 is a front view illustrating an additional embodiment of a fishing hook.

FIG. 11 is a sectional view of the fishing hook of FIG. 10 along the plane B-B.

FIG. 12 is a longitudinal sectional view of the light-emitting element of the fishing hook of FIG. 10.

FIG. 13 is an explanatory diagram of a use state of the fishing hook of FIG. 10.

FIG. 14 includes front views illustrating variation of the fishing hook of FIG. 10, FIG. 14(a) illustrating an embodiment with two hooks and FIG. 14(b) illustrating an embodiment filamentous body.

### DETAILED DESCRIPTION OF THE PREFERRED EMBODIMENT

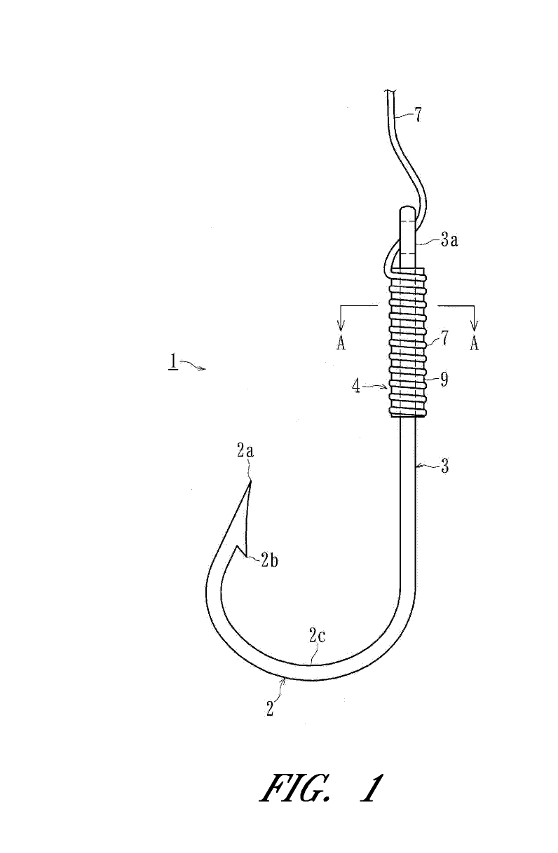

FIGS. 1 to 9 illustrate an embodiment of a fishing hook 1. The fishing hook 1 can be used for fishing and can be used with natural bait or artificial bait imitating natural bait. As illustrated in FIG. 1, the fishing hook 1 can have a hook portion 2 formed by bending a wire such as a high-carbon steel wire, a high-carbon stainless steel wire or other suitable material into a substantially C-shape. The fishing hook 1 can also include a hook body 3 forming a continuous part with the hook portion 2.

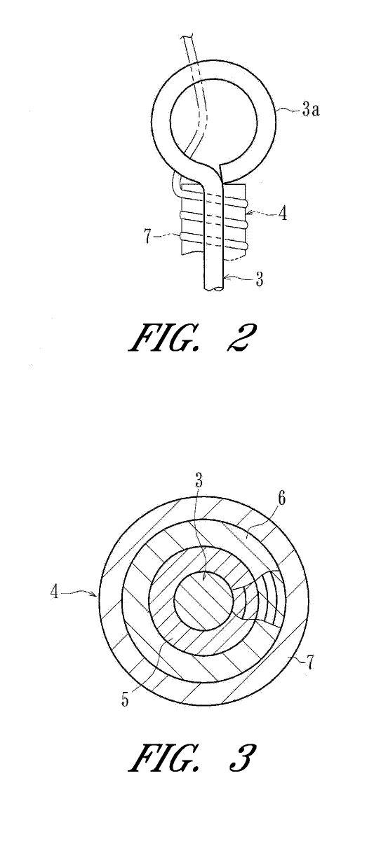

The hook portion 2 can include a point 2a provided at a hook tip end thereof, a barb 2b provided on the base end side of the point 2a, and a substantially C-shaped bent portion 2c. Moreover, on a base end side of the hook body 3, a ring-shaped line attachment portion 3a can be formed, as illustrated in FIG. 2. A light-emitting element 4 having a length L and an outer diameter d (see FIG. 4) can be attached to the line attachment portion 3a side of the fishing hook 1, which is the base end side of the hook body 3.

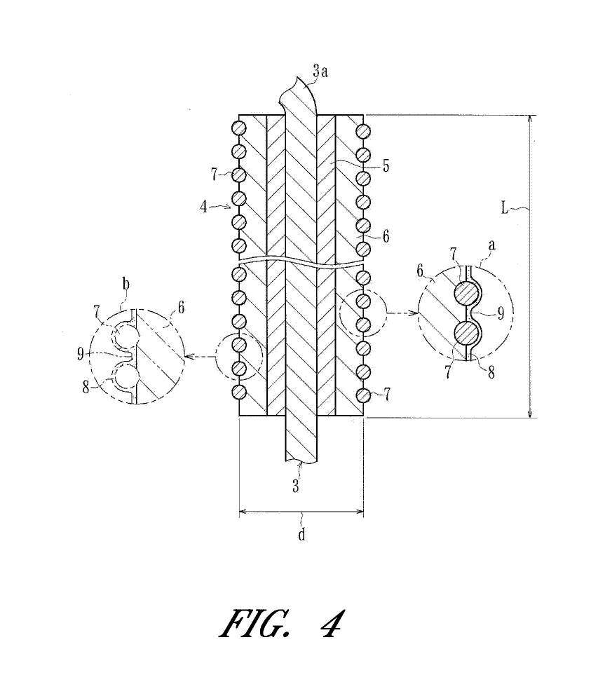

The light-emitting element 4 can include a light-emitting sheet 5 (e.g., a film, a tape and/or the like) wound around an outer peripheral surface of the hook body 3 a certain number of times (e.g., one or several turns). In some embodiments, the light-emitting element 4 can include a multilayer polymer film 6 (e.g., a sheet, a tape and/or the like) wound around the surface side of this light-emitting sheet 5 a certain number of times (e.g., one or several turns) as illustrated in FIGS. 3 and 4. An end portion of a fishing line 7 can be wound spirally around the outer peripheral surface of the multilayer polymer film 6, and can be affixed by a transparent adhesive 8 (See FIG. 4).

In the illustrated embodiment, the fishing line 7 can extend through the line attachment portion 3a of the hook body 3 or can be wounded around and affixed thereto at the base end side (e.g., the upper side in FIG. 1) of the fishing hook 1, the fishing line 7 extending upward by a certain length. By the winding of the fishing line 7, an uneven surface 9 (see FIGS. 1 and 4) can be formed on the outer peripheral surface of the light-emitting element 4.

According to some embodiments, the light-emitting sheet 5 is formed of a sheet having a certain color tone (e.g., a solid color or a plurality of colors) with high visibility from one surface side (e.g., the multilayer polymer film 6 side). For example, patterns (e.g., stripes, dots, waves, etc.) and/or images can be applied to the light-emitting sheet. The light emitting sheet 5 can also include a second surface side (e.g., the hook body 3 side) that is transparent or substantially transparent. In some embodiments, the second side can have a high degree of transparency, and thus can be considered to possess “excellent transparency.” For example, the light-emitting sheet can be formed by applying (e.g., printing) a light-emitting paint (e.g., a luminescent material) containing a phosphorescent material and/or a fluorescent material on a transparent resin sheet having flexibility. Moreover, the multilayer polymer film 6 can be formed of a multilayer polymer film (e.g., the product named Aurora film, or Marble) having a molecular arrangement of optically separating, interfering with, and reflecting a spectrum of light and having an light-interference phenomenon in a certain color tone. In some embodiments, the second surface side of the light-emitting sheet is translucent, opaque, or substantially opaque.

For example, light-emitting sheets 5 and multilayer polymer films 6 having color tones which result in catching certain kinds of fish can be obtained through experiments or the like and can be used in accordance with the type of target fish. Furthermore, a transparent and/or colored translucent gut or the like can be used as the fishing line 7, and, a transparent instant adhesive, transparent paint or the like can be used as the adhesive 8.

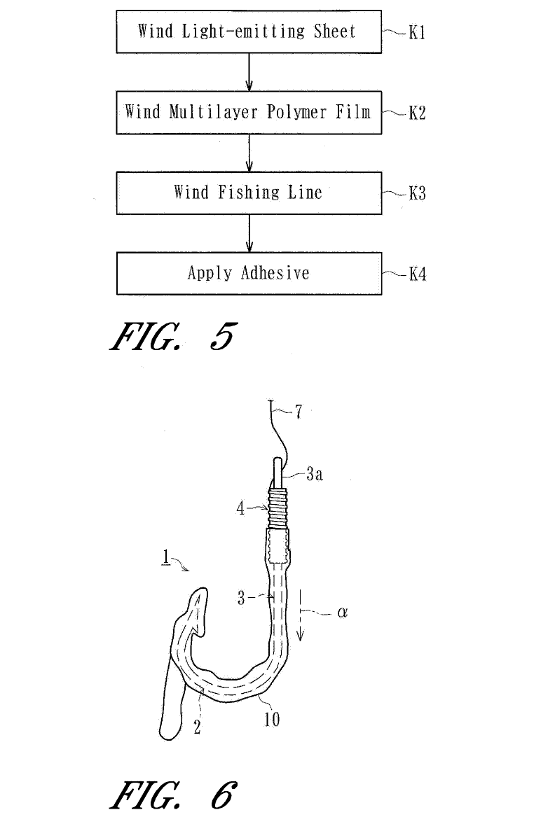

The fishing hook 1 configured as described above can be manufactured as illustrated in FIG. 5. That is, a commercially available fishing hook can be prepared. Furthermore, the light-emitting sheet 5 and the multilayer polymer film 6 can be cut to have substantially the same width. Additionally, a fishing line 7 having a certain length can be prepared. Then, the light-emitting sheet 5 can be wound (K1) on the base end side of the hook body 3 of the fishing hook. The light-emitting sheet 5 can be attached to a base material sheet (not shown) by an adhesive applied to an adhesion surface thereof, and the light-emitting sheet 5 can be wound on the outer peripheral surface of the hook body 3 a certain number of times by using the adhesive while peeling off the base material sheet.

When the light-emitting sheet 5 has been wound, the multilayer polymer film 6 can be wound on the outer peripheral surface side of the light-emitting sheet 5 (K2). The multilayer polymer film 6 can be wound on the outer peripheral surface side of the light-emitting sheet 5 in a manner similar manner in which the light-emitting sheet 5 is wound on the base end side of the hook body 3. That is, the multilayer polymer film 6 can be attached to a base material sheet (not shown) by an adhesive applied to an adhesion surface thereof and the multilayer polymer film 6 can be wound on the outer peripheral surface side of the light-emitting sheet 5 a certain number of times by using the adhesive while peeling off the base material sheet of the multilayer polymer film 6. In some embodiments, the multilayer polymer film 6 and/or the light-emitting sheet 5 are applied to the fish hook using a different method of adhesion.

In some embodiments, after the light-emitting sheet 5 and the multilayer polymer film 6 are applied to the fish hook, a transparent fishing line 7, for example, is wound (K3) on the outer peripheral surface of this multilayer polymer film 6. The winding of the fishing line 7 with a certain tensile force can cause the fishing line 7 to bite into the outer peripheral surface of the multilayer polymer film 6, as illustrated in an enlarged manner by a two-dot chain line a in FIG. 4. Such winding of the fishing line 7 can cause the multilayer polymer film 6 and the light-emitting sheet 5 to be pressed to the outer peripheral surface of the hook body 3 with a certain pressure.

The biting amount of the fishing line 7 at this time is determined in accordance with the hardness and/or other properties of the material of the multilayer polymer film 6, as illustrated in an enlarged manner by a two-dot chain line b in FIG. 4. The biting amount may be set to a minimally-bitten state and a winding pitch of the fishing line 7 may be set as appropriate in accordance with the length L or the outer diameter d of the light-emitting element 4, the shape of the fishing hook 1, and the like.

After the fishing line 7 has been wound, the transparent adhesive 8 can be applied (K4) to the front surface side of the fishing line 7, and the fishing line 7 can be affixed to the surface of the light-emitting element 4 (e.g., the outer peripheral surface of the multilayer polymer film 6). Furthermore, an uneven surface 9 can formed by the fishing line 7 on the surface of the light-emitting element 4, and separation of bait 10 from the hook body 3 can be suppressed on this uneven surface 9, as will be later described.

Next, an example of how to use the fishing hook 1 configured as described above is described below with reference to FIG. 6. The fishing hook 1 can be a fishing hook that is used for fishing using bait as described above and as illustrated in FIG. 6. The bait 10 can be natural bait such as angleworms, lugworms, sandworms, and the like. In some embodiments, the bait 10 is artificial bait formed of a resin that can be designed to imitate natural bait. The bait can be attached to the hook portion 2 and the hook body 3 of the fishing hook 1. In the illustrated embodiment, the bait 10 is attached so as to pass through the bent portion 2c and the hook body 3 from the point 2a and attached so that the end portion of the bait 10 covers the lower half, for example, of the light-emitting element 4.

As illustrated in FIG. 6, the end portion of the bait 10 which is advanced along the length of the fishing hook 1 can be secured to the fishing hook 1 by the uneven surface 9 with the fishing line 7 on the surface of the light-emitting element 4, which can inhibit the bait from separating from the fishing hook 1, unlike fishing hooks of the related art. That is, if the fishing hook is formed by merely bending a wire, as in examples of the related art, the end portion of the bait 10 can easily slip down along the smooth outer peripheral surface of the hook body as indicated by an arrow α, and the bait 10 is prevented from separating solely by the barb at the tip end of the hook portion.

On the other hand, in the case of the fishing hook 1, since the end portion of the bait 10 is secured by the uneven surface 9 of the light-emitting element 4, the end portion of the bait 10 will not easily slip down along the hook body 3 in the direction of arrow α. Furthermore, since the tip end of the bait 10 is hooked by the barb 2b, the separation of the bait 10 from the fishing hook 1 can be suppressed. Accordingly, any portion of the fishing hook 1 exposed by the separation of the bait 10 can be made as small as possible, a fish-attracting effect can be imparted to the light-emitting element 4, and a good result of catching fish can be achieved.

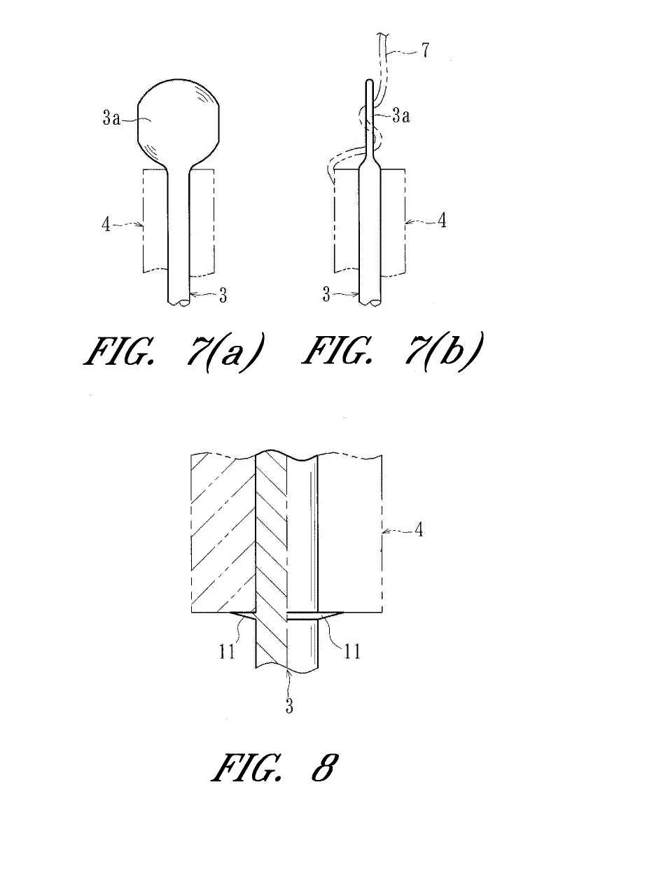

In the above-described fishing hook 1, the example in which the line attachment portion 3a of the hook body 3 has a ring shape is described. In some embodiments, as illustrated in (a) and (b) of FIG. 7, for example, the line attachment portion 3a may have a plate shape formed by flattening a wire. In such embodiments, it can be necessary to wind and affix the tip end side of the fishing line 7, wound on the outer peripheral surface of the multilayer polymer film 6 of the light-emitting element 4, to the line attachment portion 3a via an adhesive.

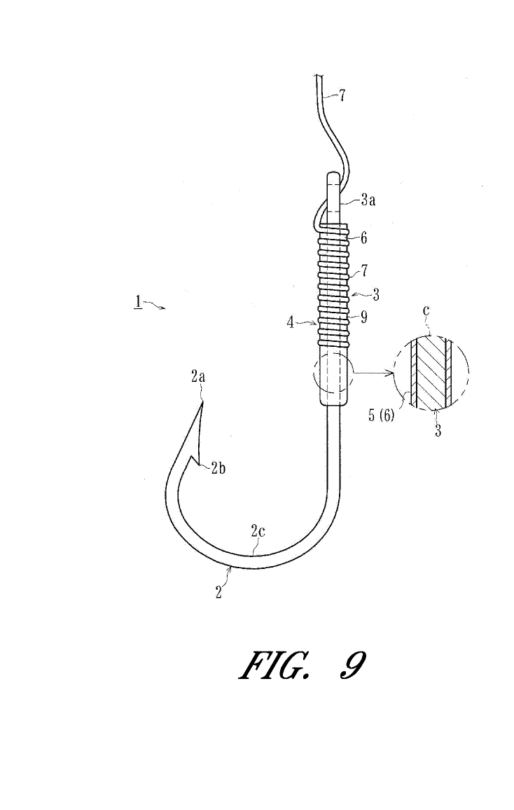

Moreover, as illustrated in FIG. 8, a line positioning portion 11 may be provided by, for example, cutting and raising the hook body 3 at a certain position on the line attachment portion 3a side. In some such embodiments, the line positioning portion 11 can be integrally formed with the hook body 3. The light-emitting element 4 may, in some cases, be attached onto the positioning portion 11. The positioning portion 11 may be formed along the whole circumference of the outer peripheral surface of the hook body 3 or may be formed on only part(s) of the outer peripheral surface of the hook body 3 in the circumferential direction. For example, the positioning portion 11 can be formed as two portions on opposite sides of the hook body 3.

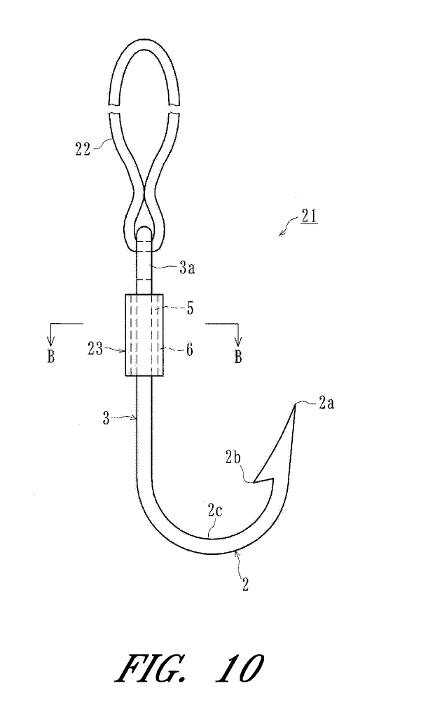

In the fishing hook 1 in the above explanation, the lengths of the light-emitting sheet 5 and the multilayer polymer film 6 of the light-emitting element 4 can be set to be equal to each other and the fishing line 7 can be wound on the outer peripheral surface of substantially the whole region in the longitudinal direction of the light-emitting element 4. However, as illustrated in FIG. 9, for example, the lower part of the light-emitting element 4 may remain exposed without winding the fishing line 7 on the outer peripheral surface thereof. In this case, as indicated by a two-dot chain line c in FIG. 9, it is needless to say that the exposed portion may only have the light-emitting sheet 5 or the multilayer polymer film 6. Moreover, in the above explanation, the end portion of the fishing line 7 (leader) is used to help affix the light-emitting element 4 (e.g., the multilayer polymer film 6 and the like) to the hook body 3. If, however, the fishing line 7 is, for example, thin, it is possible to use, instead of the fishing line 7, an affixing gut as a transparent or translucent exclusive affixing line, not shown. In this case, the end portion of the fishing line 7 can be wound and affixed to the line attachment portion 3a of the hook body 3.

In the embodiments in which the fishing hook 1 includes the light-emitting element 4, which can include the light-emitting sheet 5 configured to emit light from a phosphorescent material or luminescent material and the multilayer polymer film 6 having a light-interfering phenomenon are laminated, attached to the line attachment portion 3a side of the hook body 3 formed by bending a wire, the light-emitting element 4 can brilliantly flash during the daytime and also emit light and shine at night. As such, a sufficient fish-attracting effect can be imparted to the fishing hook 1 itself.

Additionally, in the embodiments in which the light-emitting sheet 5 is formed of a sheet having high visibility from one face side and excellent transparency from the other face side, a phosphorescent action can be obtained in the light-emitting sheet 5, and light can be emitted (radiated) reliably to the multilayer polymer film 6, thereby further increasing the fish-attracting effect of the fishing hook 1 by the light-interfering phenomenon of the polymer film 6. That is, the light-emitting element brilliantly flashes by the light-interfering phenomenon of the multilayer polymer film by sunlight during the daytime, while the multilayer polymer film glitters by light accumulated in the light-emitting sheet and shines, which increases the fish-attracting effect.

Moreover, since the light-emitting sheet 5 and the multilayer polymer film 6 are wound in the laminated state on the line attachment portion 3a side of the hook body 3 and the fishing line 7 is wound and attached to the front surface side, the bait 10 such as natural bait, artificial bait imitating the natural bait or the like will not easily slip down the smooth outer peripheral surface of the hook body 3 made of a wire due to the uneven surface 9 on the surface of the fishing line 7 wound and affixed to the front surface side of the light-emitting element 4. Together with the barb 2b of the hook portion 2, the uneven surface 9 can inhibit separation of the bait 10 from the fishing hook 1, and a sufficient result of catching fish can be expected. In some embodiments, if the fishing line 7 is thin, a dedicated relatively thick affixing gut may be used to affix the light-emitting element 4 to the hook body 3, so that the affixed state of the light-emitting element 4 is stabilized, the reliable uneven surface 9 can be formed on the surface of the light-emitting element 4, and the separation of the bait 10 can be suppressed more reliably.

Moreover, since the fishing hook 1 is formed by attaching the light-emitting element 4 having the certain length L to the line attachment portion 3a side of the hook body 3, any natural bait or other bait 10, such as artificial bait imitating the natural bait, can be attached to the fishing hook 1 in a similar manner of attachment used with fishing hooks of the related art, separation of the bait 10 from the hook can be suppressed, the fishing hook can be used for various types of fishing, and the fishing hook 1 with excellent availability can be provided. Moreover, by providing the positioning portion 11 that can position the light-emitting element 4 on the hook body 3, displacement of the light-emitting element 4 can be reliably prevented, and the light-emitting element 4 can be held at a certain position on the hook body 3 in a stable state all the time. Furthermore, by exposing the light-emitting sheet 5 or the multilayer polymer film 6 of the lower part of the light-emitting element 4, the fish-attracting effect can be further increased by the light-interfering phenomenon or the like at the exposed portion.

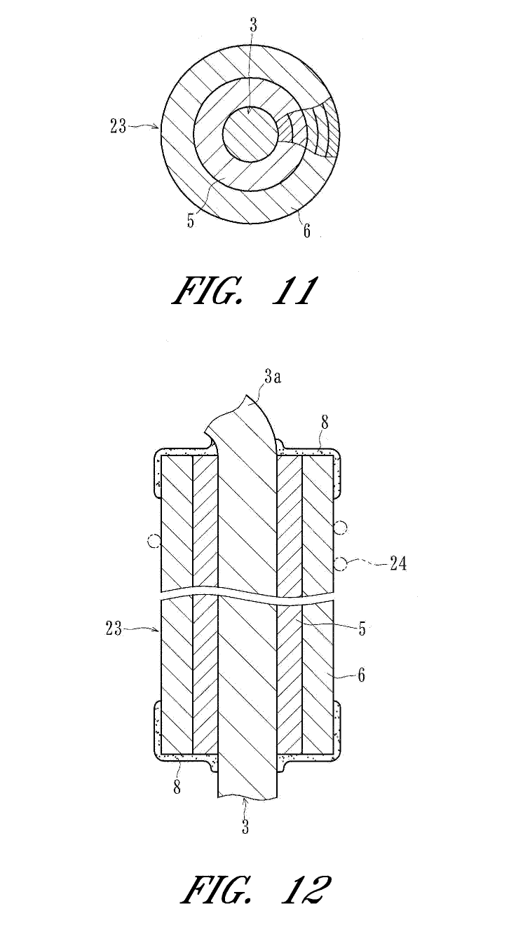

FIGS. 10 to 14 show an embodiment of a fishing hook according to the present invention. The same portions as those in the above-described embodiments are given the same reference numerals below for explanation. A fishing hook 21 of the embodiment illustrated in FIGS. 10 to 14 can be used with a lure as artificial bait, and the ring-shaped line attachment portion 3a is formed on the base end side of the hook body 3. To this line attachment portion 3a, an endless connecting line 22 made of a resin thread or the like to which a fluorescent paint is applied can be attached, and a light-emitting element 23 can be attached to the line attachment portion 3a side of the hook body 3.

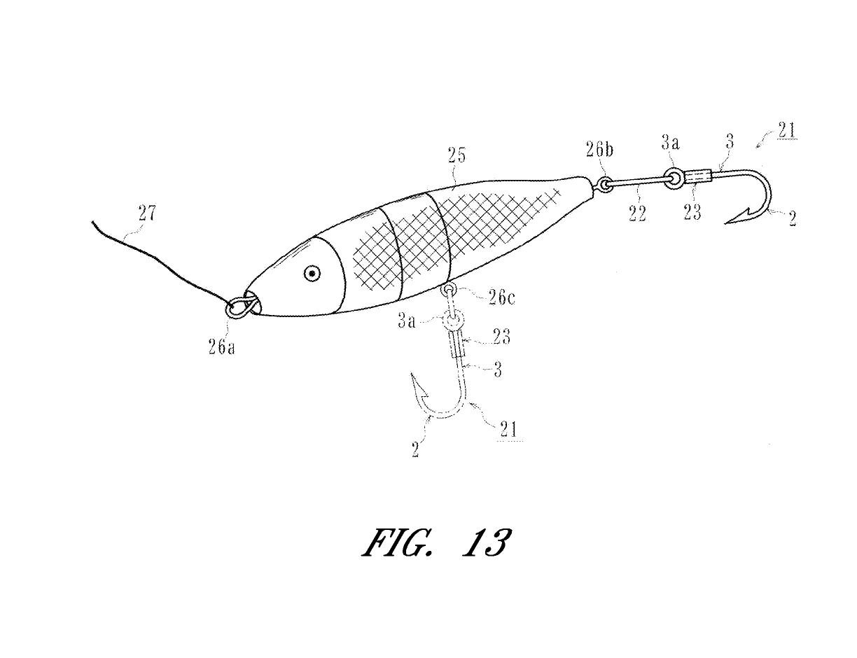

The light-emitting element 23 can have, as illustrated in FIGS. 11 and 12, a light-emitting sheet 5 wound several times on the outer peripheral surface of the hook body 3 and a multilayer polymer film 6 wound several times on the outer peripheral surface of the light-emitting sheet 5. By applying a transparent or colored adhesive 8 to upper and lower parts of the light-emitting element 23, for example, the light-emitting element 23 can be attached to the hook body 3. In this case, as indicated by a two-dot chain line of FIG. 12, the outer peripheral surface of the multilayer polymer film 6 may be wrapped with an affixing line 24 similar to the above-described affixing gut made of a transparent or colored translucent fishing line or the like functioning only for affixing, and this affixing line 24 may be affixed by the adhesive 8, so that the light-emitting element 23 is attached to the hook body 3.

The fishing hook 21 can be used as illustrated in FIG. 13. That is, the connecting line 22 of the fishing hook 21 can be connected to an eye 26b provided at a tail portion which is an end portion of a lure body 25 formed having the shape of small fish, and a fishing line 27 of a fishing rod can be connected to an eye 26a at a head part of the lure body 25. As a result, lure fishing can be performed such that the fishing hook 21 is located on the rear of the lure body 25, the lure body 25 glittering from fluorescent paint or the like provided with the lure body 25 while the light-emitting element 23 provided on the fishing hook 21 also glitters. In such an embodiment, the connecting line 22 may be set longer to 0.5 to 3 m, for example, so that the lure body 25 and the fishing hook 21 are separated from each other, and lure fishing can be performed while the lure body 23 is used as a weight.

The working effects of the fishing hook 1 in the above-described embodiment, such as increase of the fish-attracting effect by the light-emitting element 23 provided on the fishing hook 21 or the like can be obtained by using the fishing hook 21. Moreover, by setting the connecting line 22 longer as described above, the lure body 25 can be used as a weight, and the fish-attracting effect can be further increased both by the lure body 25 and the light-emitting element 23 of the fishing hook 21, and a range of applications of the fishing hook 21 can be expanded.

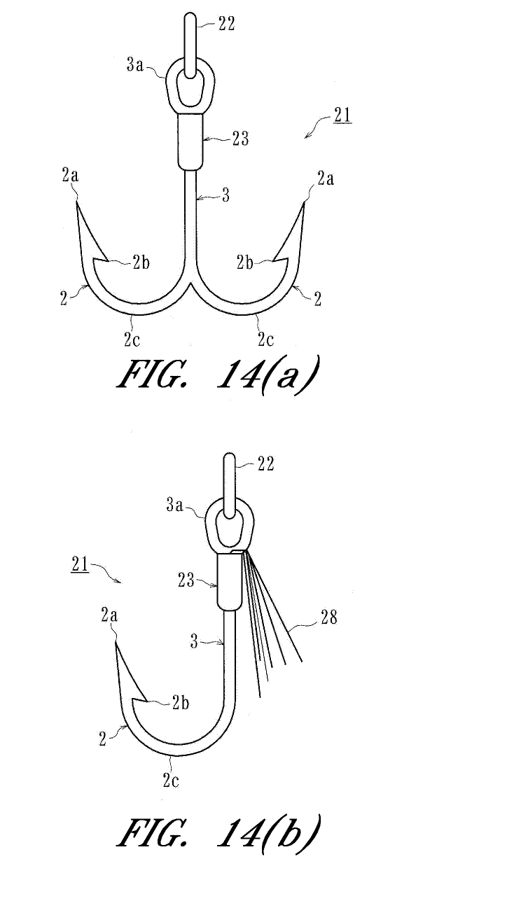

An attachment position of the fishing hook 21 to the lure body 25 is not limited to the tail portion. As illustrated in a two-dot chain line in FIG. 13, in some embodiments, the fishing hook 21 can be attached to an eye 26c provided on the belly portion of the lure body 25. Moreover, in the case of lure fishing, the form of the fishing hook 21 is not limited to a single hook but a multiple hook (e.g., two-piece hook in the figure) may be used as illustrated in FIG. 14(a). Moreover, as illustrated in FIG. 14(b), an end portion of a hook-shaped filamentous body 28 made of a plurality of resin threads in various colors of emitting light may be attached to the end portion of the light-emitting element 23 attached to the hook body 3 so as to further increase the fish-attracting effect. The filamentous body 28 can be also applied to the fishing hook 1 in other embodiments such as, for example, the fishing hook 1 of FIGS. 1 to 4. In that case, by using a filamentous body 28 made of a plurality of feather-like threads, the fishing hook 1 can be used as a fishing fly.

In some of the above-described embodiments, the fishing hook having the barb 2b provided at the hook portion 2 is described, but some embodiments of the fishing hook are not limited to that configuration but can be applied to the fishing hooks that do not have a barb 2b. Moreover, in some of the above-described embodiments, the widths of the light-emitting sheet 5 having the length L of the light-emitting element and the multilayer polymer film 6 are set to be equal to each other so that the light-interfering phenomenon becomes substantially the same in the longitudinal direction of the light-emitting elements 4 and 23. However, by winding together a plurality of light-emitting sheets 5 or multilayer polymer films 6 in different color tones or the like that can easily obtain a good result of catching fish in accordance with the type of fish. For example, different light-emitting states or different light interference phenomena can be generated in the longitudinal direction of the light-emitting elements 4 and 23.

Moreover, the light-emitting sheet 5 and the multilayer polymer film 6 wound with a plurality of layers on the hook body 3 are not limited to winding of the same material, but a plurality of the light-emitting sheets 5 in different color tones or the like may be wound in plural in a laminated state, and/or a plurality of the multilayer polymer films 6 having different light interference phenomena or the like may be wound in plural in a laminated state. Furthermore, the shape such as the shape of the hook portion 2, the length or the like of the hook body 3, the size such as the length L, the outer diameter d or the like of the light-emitting elements 4 and 23, the shape of the line attachment portion 3a or the like in each of the above-described embodiments are merely examples and can be changed as appropriate within a range not departing from the gist of each invention according to the present invention.

The present inventions are not limited to fishing hooks to be used for fishing in a river or fishing in the sea by individuals, but can be used for all the fishing hooks for fishing such as fishing hooks used by fishermen.

What is claimed is:

1. A fishing hook comprising:
a hook portion having a sharp point at the tip end, a substantially C-shaped bent portion, and a hook body forming a continuous part with the hook portion, the hook body having an attachment portion with a base end side configured to connect with a fishing line or artificial bait; and
a light-emitting element connected to the base end side of the hook body, the light-emitting element comprising a light-emitting sheet configured to emit light from a phosphorescent material or luminescent material and a multilayer polymer film having a light-interfering phenomenon.

2. The fishing hook according to claim 1, wherein
the light-emitting sheet laminated with the multilayer polymer film are wound upon the base end side of the hook body; and
the fishing line or an affixing line is wound about and affixed to the surface of the light-emitting element so as to form an uneven surface.

3. The fishing hook according to claim 1, wherein the attachment portion of the hook body is formed to have a ring shape, and a connecting line configured to connect to an eye of the artificial bait is attached to the attachment portion.

4. The fishing hook according to claim 1, wherein the light-emitting sheet is formed of a sheet having high visibility from one face side and excellent transparency from the other face side.

5. The fishing hook according to claim 1, wherein the light-emitting sheet comprises a sheet having a first surface and a second surface, the first surface facing away from the fishing hook and the second surface facing toward the fishing hook, and wherein the first surface of the sheet comprises at least one color configured to increase the visibility of the sheet.

6. The fishing hook according to claim 5, wherein the second surface is transparent or substantially transparent.

7. The fishing hook according to claim 1, wherein a filamentous body made of a plurality of threads is attached to the outside of the light-emitting element.

8. A fishing hook comprising:
a hook portion having a sharp point at the tip end, a substantially C-shaped bent portion, and a hook body forming a continuous part with the hook portion, the hook body having an attachment portion with a base end side configured to connect with a fishing line or artificial bait, wherein
a light-emitting means is connected to the base end side of the hook body, the light-emitting means configured to emit light.

9. The fishing hook according to claim 8, wherein the fishing line or an affixing line is wound about and fixed to the light-emitting means so as to form an uneven surface.

10. The fishing hook according to claim 8, wherein the attachment portion of the hook body is formed to have a ring shape, and a connecting line configured to connect to an eye of the artificial bait is attached to the attachment portion.
